(19) United States
(12) Patent Application Publication
(10) Pub. No.: US 2025/0305397 A1
(43) Pub. Date: Oct. 2, 2025

(54) COMPOSITIONS AND METHODS FOR CONTROLLING ASPHALTENE DEPOSITION

(71) Applicant: ChampionX LLC, Sugar Land, TX (US)

(72) Inventors: Jeremy Wayne Bartels, Sugar Land, TX (US); Fang Wei, Houston, TX (US); Emily Teresa Laurent, Pearland, TX (US); Corbin Julian Metoyer, Pearland, TX (US); Rebecca Michele Lucente-Schultz, Missouri City, TX (US); Christopher Alexander Russell, Sugar Land, TX (US)

(21) Appl. No.: 19/095,272

(22) Filed: Mar. 31, 2025

Related U.S. Application Data
(60) Provisional application No. 63/572,603, filed on Apr. 1, 2024.

(51) Int. Cl. E21B 43/16; C09K 8/524; E21B 43/01

(52) U.S. Cl. CPC E21B 43/162; C09K 8/524; E21B 43/01; C09K 2208/32

(57) ABSTRACT

Methods of recovering a hydrocarbon from a subterranean reservoir include combining a solvent with 0.1 ppm to 10,000 ppm by weight of one or more sulfonate polymers to form a treatment composition; contacting the treatment composition with a crude oil disposed within the reservoir to form a treated crude oil; and collecting the treated crude oil from the reservoir. The sulfonate polymers are selected from poly(methylene naphthalene sulfonate) homopolymers and copolymers, branched or crosslinked polymers having pendant benzenesulfonate moieties, and any combination thereof. The treatment compositions are suitable for umbilical injection into a subsea reservoir. The treated crude oils obtain a 30%-99% reduction in asphaltene fouling compared to an untreated crude oil obtained from the same reservoir.

### BACKGROUND

During the recovery of crude oil from a wellhead, one or more chemicals are often employed to obtain control of the properties of the crude oil stream. Thus, for example, one or more antipolymerants, dispersants, corrosion inhibitors, and the like are routinely applied at a wellhead by an operator in order to obtain control of the properties of the crude oil emanating therefrom and also to maintain the operability of oil recovery and processing equipment over time by preventing corrosion of surfaces contacted by the crude oil, and further preventing precipitation of e.g. waxes and polymerized reaction products within the pipes and tanks used in the recovery process, and. The chemistries employed in such control formulations generally improve efficiency of the oil recovery process by ensuring a consistent flow of crude oil, and by maintaining operability and minimizing down time of the mechanical equipment that contacts the crude oil during recovery, refining, and storage thereof.

Asphaltenes are a solubility class of crude oil, defined as the crude oil fraction that is soluble in aromatic solvents and insoluble in n-alkanes. ASTM D-3279-90 defines asphaltenes as solids that precipitate when an excess of n-heptane or pentane is added to a crude oil. Asphaltene molecules have complex structures and may precipitate from crude oil during extraction, forming deposits on the internal surface of the production system and accumulating particularly within equipment with high crude oil residence time. Asphaltenes are typically stable under virgin reservoir conditions, but during production, they can become destabilized and precipitate due to changes in temperature, pressure, with further dependence on the specific chemical composition of the crude oil extracted. Asphaltene deposition interferes with crude oil flow and processing, causing emulsion formation and/or stabilization within the flow, as well as heat exchanger fouling, and the like.

Accordingly, there is an ongoing need for development of chemicals that reduce or prevent deposition of asphaltenes from crude oil during recovery of the crude oil from a producing wellhead. This need is greatest in the offshore oil and gas industry, where umbilical lines, or “umbilicals”, are used to convey control and production treatment fluids from a platform on the sea surface to a subsea wellhead. As oil production obtains increasingly marginal field developments and ever-increasing water depths, emphasis is increasingly placed on remote and deepwater subsea production systems, where the umbilical is one of the most critical components of complex subsea oil recovery systems.

Operationally, fluids transported via umbilicals must withstand the harsh environmental conditions to which they are subjected not just at the wellhead, but while traversing the umbilical toward the wellhead to obtain injection. An injection fluid traversing an umbilical to a subsea depth of 1200-1550 m may be subjected to pressures of about 40 MPa at the wellhead, and is further subjected to widely variable temperatures during the traversing. For example, a temperature within a reservoir may be as high as 90° C., or even higher, while the temperature at the subsea mud-line is often less than 20° C., in some cases as low as 0-5° C.

Accordingly, there is an ongoing need for development of chemicals that reduce or prevent deposition asphaltene in crude oil, and further are sufficiently stable in an injection fluid for umbilical injection into subsea wellheads.

### SUMMARY

Disclosed herein are treatment compositions comprising, consisting essentially of, or consisting of 0.1 ppm to 10,000 ppm by weight of one or more sulfonate polymers in a solvent, wherein the one or more sulfonate polymers are selected from poly(methylene naphthalene sulfonate) homopolymers and copolymers, branched or crosslinked polymers having pendant benzenesulfonate moieties, and any combination thereof; and the solvent is a compound or a mixture of compounds that is liquid within at least a portion of the range between 0° C. and 100° C. at 1 atmosphere pressure, and includes one or more compounds having a flashpoint of 100° C. or less. In embodiments, the solvent is insoluble in water, that is, less than 1 wt % of the solvent is soluble in pure water at 15° C./1 atm. In embodiments the solvent is selected from toluene, xylene, heavy aromatic naphtha, diesel fuels, kerosenes, heavy aromatic distillates, gasolines, or any mixture thereof. In embodiments, the treatment composition includes 0.1 ppm to 1000 ppm by weight of the sulfonate polymer in the solvent. In embodiments, the treatment composition is a solution.

In embodiments, the treatment composition further includes one or more sulfonate salts having the formula (R—SO³)ₙXⁿ⁺, wherein n is an integer between 1 and 4, R is a hydrocarbyl moiety having between 10 and 40 carbons, or between 10 and 30 carbons, or between 12 and 40 carbons, or between 12 and 30 carbons, or between 16 and 40 carbons, or between 16 and 30 carbons; and R optionally further includes one or more hydroxyl moieties; and where n=1, X is Na, Ka, Li, K, NH₄, NH₃—CH₂—CH₂—OH, or NH₂(CH₂—CH₂—OH)₂; where n=2, X is Mg, Zn, Zr, Ba, or Ca; where n=3, X is Al, Mn, or Fe; and where n=4, X is Ti or Zr.

In embodiments, the treatment composition comprises a total of 0.1 ppm to 10,000 ppm by weight of the combination of the one or more sulfonate polymers and the one or more sulfonate salts. In embodiments, the weight ratio of the one or more sulfonate salts to the one or more sulfonate polymers is between 100:1 and 1:100. In embodiments, the sulfonate polymer includes one or more repeating units having formula (a):

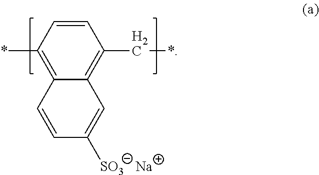

In embodiments the sulfonate polymer is a homopolymer. In embodiments the sulfonate polymer having one or more repeating units (a) is a copolymer further comprising one or more repeating units derived from the condensation of formaldehyde with phenol, resorcinol, or a combination thereof. In embodiments, the treatment composition further includes one or more adjuvants selected from: one or more antipolymerants, one or more paraffin inhibitors, one or more corrosion inhibitors, one or more antiscale agents, one or more defoaming agents, one or more emulsifiers, one or more demulsifiers, and one or more biocides.

In embodiments, the treatment composition is disposed within a subsea umbilical, wherein the subsea umbilical is in fluid contact with a subsea reservoir. In some such embodiments, the fluid contact takes place within a wellhead of the subsea reservoir or proximal to a wellhead of the subsea reservoir. In some embodiments, the subsea umbilical is one part of a subsea tree.

Also disclosed herein are treated crude oils. A treated crude oil includes a crude oil and 0.1 ppm to 10,000 ppm by weight of one or more sulfonate polymers selected from poly(methylene naphthalene sulfonate) homopolymers and copolymers, branched or crosslinked polymers having pendant benzenesulfonate moieties, and any combination thereof. In embodiments, the one or more sulfonate polymers includes a poly(sodium methylene naphthalene sulfonate) homopolymer. In some embodiments, a treated crude oil includes a crude oil and 0.1 ppm to 10,000 ppm by weight of a mixture of one or more sulfonate polymers with one or more sulfonate salts. In some embodiments, the mixture comprises a weight proportion of the one or more sulfonate polymers to the one or more sulfonate salts of 100:1 to 1:100. In embodiments, a treated crude oil obtains a 30%-99% reduction in asphaltene fouling compared to an untreated crude oil obtained from the same reservoir.

Also disclosed herein are methods of recovering a hydrocarbon from a reservoir, the methods including: combining a solvent with 0.1 ppm to 10,000 ppm by weight of one or more sulfonate polymers to form a treatment composition; contacting the treatment composition with a crude oil disposed within the reservoir to form a treated crude oil; and collecting the treated crude oil from the reservoir. In embodiments the method includes further combining one or more sulfonate salts with the one or more sulfonate polymers and the solvent to form the treatment composition. In some such embodiments, the solvent is combined with 0.1 ppm to 10,000 ppm by weight of a mixture of one or more sulfonate polymers with one or more sulfonate salts. In embodiments, the reservoir is a subsea reservoir, and the contacting includes applying the injection composition to a subsea umbilical, and flowing the injection composition through the subsea umbilical and into the subsea reservoir. In embodiments, a temperature proximal to the treatment composition during the flowing is between 0° C. and 90° C. In embodiments, a temperature proximal to the treatment composition varies by 5° C. to 90° C. during the flowing. In embodiments, a pressure proximal to the treatment composition during the flowing is 0.1 MPa to 40 MPa. In embodiments, a pressure proximal to the treatment composition varies by 0.1 MPa to 40 MPa during the flowing.

### DETAILED DESCRIPTION

Various embodiments will now be described in detail. Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

### Definitions

As used herein, the term “asphaltene” refers to the component of crude oil, bitumen, or coal that is toluene-soluble and n-heptane-insoluble; in embodiments, asphaltene is a solid, or consists essentially of a solid at 25° C./1 atm.

As used herein, “asphaltene fouling”, “asphaltene deposition”, and like terms refers to the association of asphaltene with a solid-liquid interface; unless otherwise determined by context, asphaltene fouling refers to the deposition of asphaltene from a crude oil onto the surface of one or more tubes, pipes, or other equipment contacted with the crude oil during extraction and transport thereof.

As used herein, the term “solvent” means a single compound or a mixture of two or more compounds, wherein the compound or mixture thereof is substantially liquid within at least a portion of the range between 0° C. and 100° C. at 1 atm.

As used herein, the term “soluble”, “dissolved” and similar terms as applied generally to a compound in a liquid means 1 wt % or more of the compound is dissolved or is capable of dissolving in the liquid at 15° C./1 atm. As applied to a polymer in a liquid, “soluble”, “dissolved” and similar terms further indicate that the polymer is completely solvated and homogeneously dispersed within the liquid, or is capable of becoming completely solvated and homogeneously dispersed in the liquid.

As used herein the term “insoluble” as applied generally to a compound in a liquid means less than 1 wt % or more of the compound is dissolved or is capable of dissolving in the liquid at 15° C./1 atm.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations.

The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### DISCUSSION

### First Embodiments

In first embodiments herein, first treatment compositions are disclosed. The first treatment compositions comprise, consist essentially of, or consist of a sulfonate polymer combined or mixed with a solvent. In embodiments, the first treatment compositions comprise, consist essentially of, or consist of a sulfonate polymer dissolved in a solvent.

In first embodiments, the sulfonate polymer includes one or more sulfonate repeating units, that is, one or more repeating units having one or more sulfonate moieties bonded thereto. In embodiments, the total number of sulfonate repeating units in the sulfonate polymer is between 1 and 10,000. In embodiments, the sulfonate polymer is a sulfonate homopolymer; in other embodiments the sulfonate polymer is a sulfonate copolymer. In embodiments, a sulfonate homopolymer consists of single sulfonate repeating unit, repeated 3 to 10,000 times. In embodiments, a sulfonate copolymer includes one or more sulfonate repeating units and one or more additional repeating units, wherein the total number of repeating units is between 3 and 10,000. In embodiments, one or more of the one or more additional repeating units of the sulfonate copolymer includes one or more sulfonate moieties—that is, the copolymer includes two or more different sulfonate repeating units. In embodiments, one or more of the additional repeating units excludes sulfonate moieties.

In first embodiments, the sulfonate polymer includes one or more sulfonate homopolymers, one or more sulfonate copolymers, or a mixture of one or more sulfonate homopolymers with one or more sulfonate copolymers, in any ratio. For example, two or more different sulfonate homopolymers; two or more different sulfonate copolymers; or one or more sulfonate homopolymer and one or more sulfonate copolymer may be suitably admixed together, or are formed together as a result of the synthetic method employed to result in the sulfonated polymer used in the treatment compositions.

In some first embodiments, the sulfonate polymer comprises, consists essentially of, or consists of a poly(methylene naphthalene sulfonate), which is formed by the condensation of β-naphthalene sulfonic acid with formaldehyde to obtain a poly(methylene naphthalene sulfonic acid), or pMNSA; and neutralization of some or all of the sulfonic acid moieties of the pMNSA to the corresponding conjugate base, a poly(methylene naphthalene sulfonate) (pMNS). In embodiments, the pMNSA is a homopolymer that is a formaldehyde condensate of β-naphthalene sulfonic acid. In other embodiments, the pMNSA is a copolymer that includes at least one repeat unit attributable to the condensation of formaldehyde with β-naphthalene sulfonic acid; at least one repeat unit attributable to the condensation of a formaldehyde with phenol, resorcinol, or another aromatic compound, or a mixture of two or more thereof; and a total of at least three (3) repeat units.

In embodiments, contacting a pMNSA with a metal hydroxide obtains a metal sulfonate polymer, that is, a conjugate base of the pMNSA, which is a poly(metal methylene naphthalene sulfonate). In embodiments, the metal hydroxide has the formula Xⁿ⁺(OH)ₙ wherein n is 1, 2, 3, or 4; and where n is 1, X comprises, consists essentially of, or consists of Na, Ka, Li, K, NH₄, NH₃—CH₂—CH₂—OH, NH₂(CH₂—CH₂—OH)₂, or a mixture of two or more thereof; where n is 2, X comprises, consists essentially of, or consists of Mg, Zn, Zr, Ba, Ca, or a mixture of two or more thereof; where n is 3, X comprises, consists essentially of, or consists of Al, Mn, or Fe or a mixture of two or more thereof; and where n is 4, X comprises, consists essentially of, or consists of Ti, Zr, or a mixture thereof. In embodiments, upon contacting a pMNSA with a metal hydroxide, the pMNSA is partially or completely converted to the conjugate base thereof; that is, in some embodiments, all or substantially all of the sulfonic acid moieties of the pMNSA are converted to the conjugate base thereof (sulfonate); in other embodiments, only some of the sulfonic acid moieties of the pMNSA are converted to the conjugate base thereof.

In embodiments, contacting a pMNSA with sodium hydroxide obtains a sodium sulfonate polymer that is a poly(sodium methylene naphthalene sulfonate), or NaMNS.

Similarly, contacting pMNSA with lithium hydroxide obtains a lithium sulfonate polymer that is a poly(lithium methylene naphthalene sulfonate), or LiMNS; contacting pMNSA with potassium hydroxide obtains a potassium sulfonate polymer that is a poly(potassium methylene naphthalene sulfonate), or KMNS; contacting pMNSA with ammonium hydroxide obtains an ammonium sulfonate polymer that is a poly(ammonium methylene naphthalene sulfonate), or NH₄MNS; and contacting pMNSA with ethanolammonium hydroxide or diethanolammonium hydroxide obtains (EtONH₃)MNS or ((EtO)₂NH₂)MNS, respectively.

In some first embodiments, a pMNS includes one more repeat units having structure (a) as shown below, wherein m is an integer of 1 or more, and X is Na, Ka, Li, K, NH₄, NH₃—CH₂—CH₂—OH, NH₂(CH₂—CH₂—OH)₂, or a mixture of two or more thereof (that is, different pMNS repeat units can have different X):

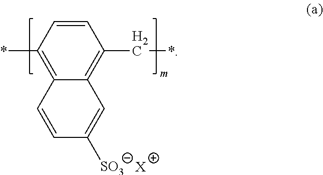

In some first embodiments, the pMNS of structure (a) is a homopolymer, wherein m is an integer between 3 and 10,000, for example between 5 and 10,000; or between 10 and 10,000; or between 25 and 10,000; or between 50 and 10,000; or between 75 and 10,000; or between 100 and 10,000; or between 200 and 10,000; or between 300 and 10,000; or between 500 and 10,000; or between 700 and 10,000; or between 1000 and 10,000; or between 2000 and 10,000; or between 3000 and 10,000; or between 5000 and 10,000; or between 7000 and 10,000; or between 3 and 7,000; or between 3 and 5,000; or between 3 and 3,000; or between 3 and 2,000; or between 3 and 1,000; or between 3 and 500; or between 3 and 300; or between 3 and 200; or between 3 and 100; or between 3 and 50; or between 3 and 10; or between 3 and 5; or between 5 and 10; or between 10 and 50; or between 50 and 100; or between 100 and 300; or between 300 and 500; or between 500 and 700; or between 700 and 1000; or between 1000 and 2000; or between 2000 and 3000; or between 3000 and 5000; or between 5000 and 7000; or between 7000 and 10,000.

In some first embodiments, the pMNS of structure (a) is a pMNS copolymer comprising, consisting essentially of, or consisting of a total of at least three (3) repeating units, further wherein at least one of the repeating units has structure (a), that is, wherein m of structure (a) is at least 1. In other embodiments, the pMNSA is a copolymer further includes at least one additional repeating unit attributable to the condensation of a formaldehyde with phenol, resorcinol, or another aromatic compound, or a mixture of two or more thereof. In embodiments, the total number of repeating units in a pMNS copolymer, that is the total number of repeating units having structure (a) plus the total number of additional repeating units, is between 3 and 10,000, for example between 5 and 10,000; or between 10 and 10,000; or between 25 and 10,000; or between 50 and 10,000; or between 75 and 10,000; or between 100 and 10,000; or between 200 and 10,000; or between 300 and 10,000; or between 500 and 10,000; or between 700 and 10,000; or between 1000 and 10,000; or between 2000 and 10,000; or between 3000 and 10,000; or between 5000 and 10,000; or between 7000 and 10,000; or between 3 and 7,000; or between 3 and 5,000; or between 3 and 3,000; or between 3 and 2,000; or between 3 and 1,000; or between 3 and 500; or between 3 and 300; or between 3 and 200; or between 3 and 100; or between 3 and 50; or between 3 and 10; or between 3 and 5; or between 5 and 10; or between 10 and 50; or between 50 and 100; or between 100 and 300; or between 300 and 500; or between 500 and 700; or between 700 and 1000; or between 1000 and 2000; or between 2000 and 3000; or between 3000 and 5000; or between 5000 and 7000; or between 7000 and 10,000.

In some first embodiments, a pMNS copolymer includes a proportion of sulfonated repeating units to non-sulfonated repeating units (that is, repeating units having no sulfonate moiety) of 100:1 to 1:100, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1.

In some first embodiments, the sulfonate polymer is a branched alkaryl backbone with pendant benzenesulfonate moieties. One exemplary branched sodium benzenesulfonate polymer structure is represented by structure (b). Other similar sulfonate polymer structures are contemplated. Conventionally, in some embodiments, branched or crosslinked polymers having pendant benzenesulfonate moieties are employed industrially as ion exchange resins.

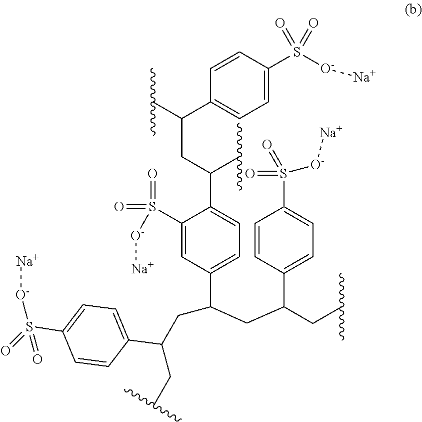

Accordingly, in first embodiments, a first treatment composition comprises, consists essentially of, or consists of a solvent and one or more of the foregoing sulfonate polymers. In embodiments, the solvent is a single compound or a mixture of two or more compounds, wherein the compound or mixture thereof is substantially liquid within at least a portion of the range between 0° C. and 100° C. at 1 atmosphere pressure. In embodiments, the solvent is insoluble in water, that is, less than 1 wt % of the compound dissolves in pure water at 15° C./1 atm. In some first embodiments, the sulfonate polymer is soluble in the solvent, that is, more than 1 wt % of the sulfonate polymer is dissolved in or is capable of dissolving in the solvent at 15° C./1 atm, wherein “soluble” as applied to a polymer in a solvent means that the polymer is completely solvated and homogeneously dispersed within the solvent. In some such embodiments, more than 2 wt %, more than 5 wt %, more than 10 wt %, even more than 20 wt % of the sulfonate polymer is capable of dissolving in the solvent at 15° C./1 atm.

In embodiments, the solvent comprises, consists essentially of, or consists of an aromatic solvent selected from toluene, xylene, heavy aromatic naphtha, or a mixture of two or more thereof. In embodiments, the solvent comprises, consists essentially of, or consists of a fuel fluid selected from diesel fuels, kerosenes, heavy aromatic distillates, or gasolines. In embodiments, the solvent comprises, consists essentially of, or consists of a mixture of one or more aromatic solvents with one or more fuel fluids, in a weight ratio between 100:1 and 1:100 by weight, for example for 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 by weight. In some embodiments, the solvent excludes C5-C12 aliphatic hydrocarbons, which include but are not limited to hexane, heptane, decane, and the like.

In embodiments the solvent comprises, consists essentially of, or consists of one or more compounds that are flammable, that is, the solvent includes one or more compounds having a flashpoint of 100° C. or less. In embodiments the solvent comprises, consists essentially of, or consists of one or more compounds having a flashpoint of 100° C. or less, and/or one or more compounds having a flashpoint of 90° C. or less, and/or one or more compounds having a flashpoint of 80° C. or less, and/or one or more compounds having a flashpoint of 70° C. or less, and/or one or more compounds having a flashpoint of 60° C. or less, and/or one or more compounds having a flashpoint of 50° C. or less, and/or one or more compounds having a flashpoint of 40° C. or less. In embodiments the solvent comprises, consists essentially of, or consists of one or more compounds having a flashpoint between 20° C. and 30° C., and/or one or more compounds having a flashpoint between 30° C. and 40° C., and/or one or more compounds having a flashpoint between 40° C. and 50° C., and/or one or more compounds having a flashpoint between 50° C. and 60° C., and/or one or more compounds having a flashpoint between 60° C. and 70° C., and/or one or more compounds having a flashpoint between 70° C. and 80° C., and/or one or more compounds having a flashpoint between 80° C. and 90° C., and/or one or more compounds having a flashpoint between 90° C. and 100° C.

In embodiments the solvent includes one or more compounds that are combustible, that is, the solvent includes one or more compounds having a flashpoint between 100° C. and 150° C. In embodiments the solvent comprises, consists essentially of, or consists of one or more compounds having a flashpoint between 100° C. and 110° C., and/or one or more compounds having a flashpoint between 110° C. and 120° C., and/or one or more compounds having a flashpoint between 120° C. and 130° C., and/or one or more compounds having a flashpoint between 130° C. and 140° C., and/or one or more compounds having a flashpoint between 140° C. and 150° C. In embodiments the solvent includes a mixture of combustible and flammable compounds. In embodiments, the solvent comprises toluene, xylene, heavy aromatic naphtha, diesel, kerosene, heavy aromatic distillate, gasoline, or any combination thereof.

In first embodiments, the first treatment composition comprises, consists essentially of, or consists of 0.1 ppm to 10,000 ppm by weight by weight or w/v (where specified) of one or more sulfonated polymers in a solvent, for example 1 ppm to 10,000 ppm, or 10 ppm to 10,000 ppm, or 50 ppm to 10,000 ppm, or 100 ppm to 10,000 ppm, or 200 ppm to 10,000 ppm, or 300 ppm to 10,000 ppm, or 400 ppm to 10,000 ppm, or 500 ppm to 10,000 ppm, or 600 ppm to 10,000 ppm, or 700 ppm to 10,000 ppm, or 800 ppm to 10,000 ppm, or 900 ppm to 10,000 ppm, or 1000 ppm to 10,000 ppm, or 1500 ppm to 10,000 ppm, or 2000 ppm to 10,000 ppm, or 3000 ppm to 10,000 ppm, or 4000 ppm to 10,000 ppm, or 5000 ppm to 10,000 ppm, or 6000 ppm to 10,000 ppm, or 7000 ppm to 10,000 ppm, or 8000 ppm to 10,000 ppm, or 9000 ppm to 10,000 ppm, or 1 ppm to 5000 ppm, or 10 ppm to 5000 ppm, or 50 ppm to 5000 ppm, or 100 ppm to 5000 ppm, or 200 ppm to 5000 ppm, or 300 ppm to 5000 ppm, or 400 ppm to 5000 ppm, or 500 ppm to 5000 ppm, or 600 ppm to 5000 ppm, or 700 ppm to 5000 ppm, or 800 ppm to 5000 ppm, or 900 ppm to 5000 ppm, or 1000 ppm to 5000 ppm, or 1500 ppm to 5000 ppm, or 2000 ppm to 5000 ppm, or 3000 ppm to 5000 ppm, or 4000 ppm to 5000 ppm, or 0.01 to 0.1 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 1000 ppm to 1500 ppm, or 1500 ppm to 2000 ppm, or 2000 ppm to 2500 ppm, or 2500 ppm to 3000 ppm, or 3000 ppm to 3500 ppm, or 3500 ppm to 4000 ppm, or 4000 ppm to 4500 ppm, or 4500 ppm to 5000 ppm, or 5000 ppm to 5500 ppm, or 5500 ppm to 6000 ppm, or 6000 ppm to 6500 ppm, or 6500 ppm to 7000 ppm, or 7000 ppm to 7500 ppm, or 7500 ppm to 8000 ppm, or 8000 ppm to 8500 ppm, or 8500 ppm to 9000 ppm, or 9000 ppm to 9500 ppm, or 9500 ppm to 10,000 ppm by weight or w/v (where specified) of one or more sulfonated polymers in a solvent. In embodiments, the one or more sulfonated polymers are dissolved in the solvent.

In embodiments, a first treatment composition further includes a total of 0.1 ppm to 10,000 ppm of one or more adjuvants selected from: one or more antipolymerants, one or more paraffin inhibitors, one or more corrosion inhibitors, one or more antiscale agents, one or more defoaming agents, one or more emulsifiers, one or more demulsifiers, and one or more biocides.

The first treatment compositions are useful for injecting into a subterranean reservoir, in particular a subsea reservoir, as is discussed in further detail herein below. Injection of the first treatment compositions into a reservoir, such as the wellhead of a reservoir, obtains a treated crude oil having unexpectedly superior asphaltene antifouling properties.

### Second Embodiments

In second embodiments herein, sulfonate mixtures are disclosed. Further in second embodiments herein, second treatment compositions are disclosed, where the second treatment compositions comprise, consist essentially of, or consist of a sulfonate mixture combined or mixed with a solvent.

The sulfonate mixtures of second embodiments comprise, consist essentially of, or consist of a mixture of one or more sulfonate polymers as described in first embodiments above, with one or more sulfonate salts. A sulfonate salt is a conjugate base of a sulfonic acid having the formula R—SO₃H, wherein R is an organic group. In embodiments, R is a hydrocarbyl moiety. In embodiments, R is a linear, branched, or cyclic aliphatic, aromatic, aralkyl, or alkaryl moiety. In embodiments, R includes between 10 and 40 carbon atoms. In embodiments, R is naphthalene, isododecyl, 2,3-diisononylnaphthyl, or 2,3-diisononylphenyl. In embodiments, R further includes one or more oxygen atoms. In embodiments, one or more of the one or more oxygen atoms is part of a hydroxyl group.

In some second embodiments, the sulfonate salt has the formula (R—SO³⁻)ₙXⁿ⁺ wherein n is an integer between 1 and 4, that is, n has a value of 1, 2, 3, or 4. In embodiments, n is 1 and X is a monovalent cation or a mixture of two or more sulfonate salts having different monovalent cations. In embodiments, X comprises, consists essentially of, or consists of Na, Ka, Li, K, NH₄, NH₃—CH₂—CH₂—OH, NH₂(CH₂—CH₂—OH)₂, or a mixture of two or more thereof, further wherein a mixture of any two monovalent cations is obtained in a molar ratio of 1000:1 to 1:1000, or 500:1 to 1:500, or 100:1 to 1:100, 10:1 to 1:10, 5:1 to 1:5, 2:1 to 1:2, or even about 1:1.

In some second embodiments, the sulfonate salt has the formula (R—SO³⁻)ₙXⁿ⁺, n is 2 and X is a divalent cation or a mixture of two or more sulfonate salts having different divalent cations. In embodiments, X comprises, consists essentially of, or consists of Mg, Zn, Zr, Ba, Ca, or a mixture of two or more thereof, further wherein a mixture of any two divalent cations is obtained in a molar ratio of 1000:1 to 1:1000, or 500:1 to 1:500, or 100:1 to 1:100, 10:1 to 1:10, 5:1 to 1:5, 2:1 to 1:2, or about 1:1.

In some second embodiments, the sulfonate salt has the formula (R—SO³⁻)ₙXⁿ⁺, n is 3 and X is a trivalent cation or a mixture of two or more sulfonate salts having different trivalent cations. In embodiments, X comprises, consists essentially of, or consists of Al, Mn, or Fe or a mixture of two or more thereof, further wherein a mixture of any two trivalent cations is obtained in a molar ratio of 1000:1 to 1:1000, or 500:1 to 1:500, or 100:1 to 1:100, 10:1 to 1:10, 5:1 to 1:5, 2:1 to 1:2, or about 1:1.

In some second embodiments, the sulfonate salt has the formula (R—SO³⁻)ₙXⁿ⁺, n is 4 and X is a tetravalent cation or a mixture of two or more sulfonate salts having different tetravalent cations. In embodiments, X comprises, consists essentially of, or consists of Ti, Zr, or a mixture thereof, further wherein a mixture of any two tetravalent cations is obtained in a molar ratio of 1000:1 to 1:1000, or 500:1 to 1:500, or 100:1 to 1:100, 10:1 to 1:10, 5:1 to 1:5, 2:1 to 1:2, or even about 1:1.

In some second embodiments, the sulfonate salt is a sulfonate salt mixture, that is, a mixture of two or more different compounds having the formula (R—SO³⁻)ₙXⁿ⁺. Thus, in embodiments, a sulfonate salt mixture is a mixture of two different compounds, each having the formula (R—SO³⁻)ₙXⁿ+, wherein a first portion of the sulfonate salt mixture includes a first compound having a first value of n that is n′; and a second portion of the sulfonate salt mixture includes a second compound having a second value of n that is n″; wherein n′ and n″ are individually integers between 1 and 4, and further wherein n′ and n″ are different. Similarly, sulfonate salt mixtures including three or more different compounds, wherein each of the three or more different compounds has the formula (R—SO³⁻)ₙXⁿ⁺, and each of the three or more compounds have different values of n are contemplated. In such embodiments, the relative amounts, or molar ratios of the three of more different compounds of the sulfonate salt mixture are not particularly limited; and often obtain a molar ratio between any two such compounds of 100:1 to 1:100, 10:1 to 1:10, 5:1 to 1:5, 2:1 to 1:2, or about 1:1.

In some second embodiments, the sulfonate salt is a sulfonate salt mixture of two or more different compounds having the formula (R—SO³⁻)ₙXⁿ⁺, wherein a first portion of the sulfonate salt mixture is a first compound having a first R group that is R′; and a second portion of the sulfonate salt mixture is a second compound having a second R group that is R″; wherein a comparison of R′ and R″ obtains one or more of the following differences: different number of carbon atoms, different degree of branching, cyclic vs. branched structure, branched vs. linear structure, cyclic vs. linear structure, aromatic vs. aliphatic structure, or some other chemical, structural, or isomeric difference. In embodiments, the sulfonate salt is a mixture of two or more different compounds having the formula (R—SO³⁻)ₙXⁿ⁺ wherein the two or more different compounds have different R groups, different values of n, or both different R groups and different values of n. Accordingly, in embodiments, the sulfonate salt is a sulfonate salt mixture of two or more different compounds having the formula (R—SO³⁻)ₙXⁿ⁺, wherein a first portion of the sulfonate salt mixture is a first compound having a first R group that is R′ and a first value of n that is n′ (thus, (R′—SO³⁻)_{n″}X^{n″+}); and a second portion of the sulfonate salt mixture is a second compound having a second R group that is R″ and a second value of n that is n″ (thus, (R″—SO³⁻)_{n″}X^{n″+}); wherein n′, n″, R′, and R″ are each individually defined as R and n above.

In some second embodiments the sulfonate salt is insoluble in water, that is, less than 1 wt % of the sulfonate salt dissolves in pure water at 15° C./1 atm. In other second embodiments, the sulfonate salt is soluble in water, that is, 1 wt % or more of the compound dissolves in pure water at 15° C./1 atm.

In some second embodiments, the sulfonate salt is one or more sodium sulfonates, one or more ammonium sulfonates, or a combination of two or more thereof. In embodiments the sulfonate salt comprises, consists essentially of, or consists of a salt of one or more of the following sulfonates (c)-(h):

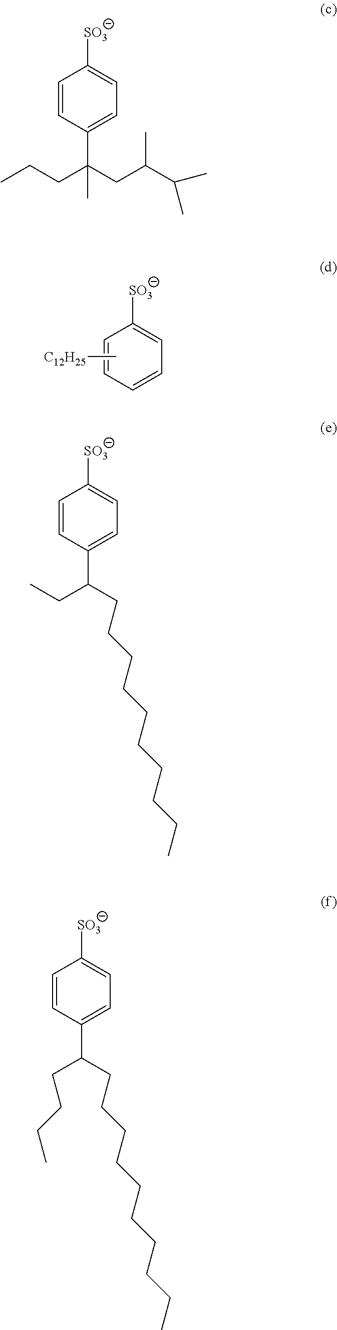

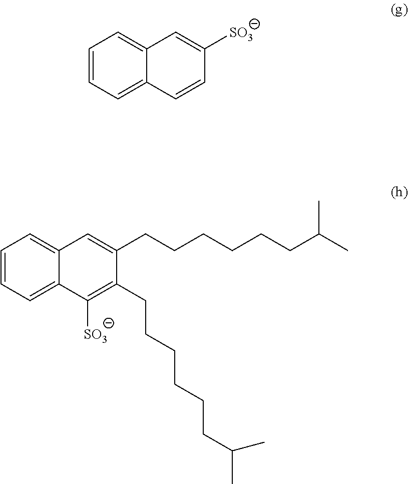

In some second embodiments, the sulfonate salt comprises, consists essentially of, or consists of an overbased sulfonate detergent or a highly overbased sulfonate detergent. Overbased sulfonate detergents are mixtures, typically supplied as a dispersion in an oil, of an amorphous calcium carbonate particulate stabilized by a sulfonate salt.

In second embodiments, the sulfonate mixture includes a weight proportion of the one or more sulfonate polymers of first embodiments to the one or more sulfonate salts of 100:1 to 1:100, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 total sulfonate polymer weight to total sulfonate salt weight.

Accordingly, in some second embodiments, a sulfonate mixture is formed by contacting one or more sulfonate polymers of first embodiments with one or more sulfonate salts in weight a proportion of between 100:1 and 1:100, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1.

In second embodiments herein, second treatment compositions comprise, consist essentially of, or consist of any of the foregoing sulfonate mixtures further combined with a solvent. In second embodiments, the solvent is selected from any of the solvents described in first embodiments herein. In some second embodiments, the sulfonate mixture is soluble in the solvent, that is, more than 1 wt % of the sulfonate mixture is dissolved in the solvent or is capable of dissolving in the solvent at 15° C./1 atm. In some such embodiments, more than 2 wt %, more than 5 wt %, more than 10 wt %, even more than 20 wt % of the sulfonate mixture is capable of dissolving in the solvent at 15° C./1 atm.

In some such embodiments, both the sulfonate polymer and the sulfonate salt are separately or individually soluble in the solvent, wherein more than 2 wt %, more than 5 wt %, more than 10 wt %, even more than 20 wt % of the sulfonate polymer is capable of dissolving in the solvent at 15° C. and wherein more than 2 wt %, more than 5 wt %, more than 10 wt %, even more than 20 wt % of the sulfonate salt is separately capable of dissolving in the solvent at 15° C./1 atm.

Accordingly, in second embodiments, a second treatment composition includes 0.1 ppm to 10,000 ppm by weight by weight or w/v (where specified) of a sulfonate mixture in a solvent, for example 1 ppm to 10,000 ppm, or 10 ppm to 10,000 ppm, or 50 ppm to 10,000 ppm, or 100 ppm to 10,000 ppm, or 200 ppm to 10,000 ppm, or 300 ppm to 10,000 ppm, or 400 ppm to 10,000 ppm, or 500 ppm to 10,000 ppm, or 600 ppm to 10,000 ppm, or 700 ppm to 10,000 ppm, or 800 ppm to 10,000 ppm, or 900 ppm to 10,000 ppm, or 1000 ppm to 10,000 ppm, or 1500 ppm to 10,000 ppm, or 2000 ppm to 10,000 ppm, or 3000 ppm to 10,000 ppm, or 4000 ppm to 10,000 ppm, or 5000 ppm to 10,000 ppm, or 6000 ppm to 10,000 ppm, or 7000 ppm to 10,000 ppm, or 8000 ppm to 10,000 ppm, or 9000 ppm to 10,000 ppm, or 1 ppm to 5000 ppm, or 10 ppm to 5000 ppm, or 50 ppm to 5000 ppm, or 100 ppm to 5000 ppm, or 200 ppm to 5000 ppm, or 300 ppm to 5000 ppm, or 400 ppm to 5000 ppm, or 500 ppm to 5000 ppm, or 600 ppm to 5000 ppm, or 700 ppm to 5000 ppm, or 800 ppm to 5000 ppm, or 900 ppm to 5000 ppm, or 1000 ppm to 5000 ppm, or 1500 ppm to 5000 ppm, or 2000 ppm to 5000 ppm, or 3000 ppm to 5000 ppm, or 4000 ppm to 5000 ppm, or 0.01 to 0.1 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 1000 ppm to 1500 ppm, or 1500 ppm to 2000 ppm, or 2000 ppm to 2500 ppm, or 2500 ppm to 3000 ppm, or 3000 ppm to 3500 ppm, or 3500 ppm to 4000 ppm, or 4000 ppm to 4500 ppm, or 4500 ppm to 5000 ppm, or 5000 ppm to 5500 ppm, or 5500 ppm to 6000 ppm, or 6000 ppm to 6500 ppm, or 6500 ppm to 7000 ppm, or 7000 ppm to 7500 ppm, or 7500 ppm to 8000 ppm, or 8000 ppm to 8500 ppm, or 8500 ppm to 9000 ppm, or 9000 ppm to 9500 ppm, or 9500 ppm to 10,000 ppm by weight or w/v (where specified) of a sulfonate mixture in a solvent.

In embodiments, a second treatment composition further includes a total of 0.1 ppm to 10,000 ppm of one or more adjuvants selected from: one or more corrosion inhibitors, one or more antipolymerants, one or more paraffin inhibitors, one or more corrosion inhibitors, one or more antiscale agents, one or more defoaming agents, one or more emulsifiers, one or more demulsifiers, and one or more biocides.

The second treatment compositions are useful for injecting into a subterranean reservoir, in particular a subsea reservoir, as is discussed in further detail herein below. Injection of the second treatment compositions into a reservoir, such as the wellhead of a reservoir, obtains a treated crude oil having unexpectedly superior asphaltene antifouling properties.

### Third Embodiments

In third embodiments herein, first treatment compositions of first embodiments and second treatment compositions of second embodiments are referred to collectively as “the treatment compositions”, further wherein “a treatment composition” is a selected one of the first and second treatment compositions.

In third embodiments herein, methods of treating a crude oil are disclosed. The methods comprise, consist essentially of, or consist of injecting a treatment composition into a subterranean reservoir; and collecting a treated crude oil from the reservoir.

In the methods of third embodiments, the injecting causes the treatment composition to contact the contents of the reservoir prior to collecting. That is, the treatment compositions are injected at the wellhead to contact the crude oil within the reservoir, thereby forming a treated crude oil which is collected. Accordingly, the collecting of third embodiments is collecting a treated crude oil from the reservoir. In embodiments, the crude oil located within the reservoir includes asphaltene, for example between 2 wt % and 20 wt % asphaltene, depending on the location of the reservoir. In embodiments the asphaltene is dispersed, that is, entrained or included within the crude oil, and may be dissolved or partially dissolved therein; and can become associated with solid-liquid interfaces encountered during extraction of the crude oil from the reservoir—that is, cause asphaltene fouling of surfaces contacted with the untreated crude oil. The methods of third embodiments address the foregoing problem by reducing or eliminating asphaltene fouling. Accordingly, the methods of third embodiments are methods of reducing or eliminating asphaltene fouling of a crude oil, by combining the crude oil with a sulfonate polymer of first embodiments or a sulfonate mixture of second embodiments.

Accordingly, in the methods of third embodiments, treating a crude oil includes combining a treatment composition with a crude oil to obtain a treated crude oil, wherein the treated crude oil obtains a reduced amount of asphaltene fouling compared to the same crude oil prior to the combining, tested under the same conditions of temperature and pressure.

In some third embodiments, the crude oil is located in a subsea reservoir and the combining is injecting the treatment composition into a wellhead of the subsea reservoir, further wherein the injecting is flowing the treatment composition through an umbilical. An umbilical is a tube—that is, an annular conduit—extending from a first end situated above the surface of the sea to a second end in fluid contact with a subsea reservoir at a wellhead thereof. Umbilicals are widely used in the offshore oil extraction industry to convey control and production treatment fluids from a platform situated near the sea surface to the subsea wellhead.

In some third embodiments, an umbilical second end is located 50 m to 2000 m beneath the surface of a body of water, such as an ocean, sea, or freshwater lake.

Accordingly, during subsea injecting of third embodiments, a treatment composition is applied to the first end of an umbilical, located above the surface of the body of water; and the applied treatment composition flows downward through the umbilical toward umbilical second end, located within or proximal to the wellhead.

In some embodiments, a treatment composition is applied to umbilical first end, and the applied treatment composition traverses the umbilical under an applied pressure, such as a pressure applied by a direct drive pump, a hydraulic pump, or a peristaltic pump. In some third embodiments, the flow of treatment composition through the umbilical is a metered flow, wherein a selected flow rate of a treatment composition is applied through the umbilical. In some third embodiments, the flow of treatment composition through the umbilical is a controlled flow, that is, the volume of a treatment composition injected into the wellhead per unit of time is adjusted automatically or manually by an operator in response to external criteria such as the rate of flow of (treated) crude oil from the wellhead. In embodiments, the umbilical is connected to a subsea tree, and the flow of the treatment composition is controlled or metered using the subsea tree. In embodiments, subsea trees operate to control the flow both into and out of subsea a well, further while staking the umbilical and other tubes and devices for subsea oil extraction to the seafloor and also to above-water oil extraction facilities.

Accordingly, in some third embodiments, injecting a treatment composition into a subsea reservoir includes subjecting the treatment composition to temperatures varying between 0° C. and 100° C., and pressure between 0.1 MPa to 40 MPa during the injecting. Such variable conditions may be encountered during injection into a subsea reservoir, as a treatment composition flows from above sea level to the wellhead 50 m to 2000 m below the sea surface. In some embodiments of subsea injection, it is highly advantageous for the treatment composition to be in the form of a solution, and for the solution to be sufficiently stable to traverse the distance between umbilical first end and umbilical second end without undergoing phase separation, freezing, or gelation. Maintaining a solution within an umbilical is critical to maintaining flow control of chemicals into the wellhead, because precipitation or other phase separation within an umbilical annulus is particularly difficult to address in context of the subsea environment, as will be appreciated by one of ordinary skill in the art of subsea hydrocarbon recovery.

Accordingly, in embodiments, a treatment composition is a treatment solution; that is, a sulfonate polymer or a sulfonate mixture is soluble in the solvent at 15° C./1 atm. In some embodiments, a treatment solution is a stable treatment solution. A stable treatment solution is a treatment solution that does not undergo phase separation, freezing, or gelation when exposed to the conditions encountered during umbilical injecting, that is, while traversing an umbilical toward a subsea wellhead. In embodiments, a stable treatment solution applied to an umbilical obtains a solution while traversing, or flowing within, the umbilical toward the subsea wellhead. Accordingly, in some third embodiments, a stable treatment solution obtains a solution at pressures between 0.1 MPa to 40 MPa. In some third embodiments, a stable treatment solution obtains a solution at temperatures between 0° C. and 100° C. In some third embodiments, a stable treatment solution obtains a solution at temperatures between 0° C. and 100° C., further at any pressure between 0.1 MPa to 40 MPa. In some third embodiments, a stable treatment solution obtains a solution at temperatures between 0° C. and 100° C., further at any pressure between 0.1 MPa to 40 MPa, and further wherein the temperature varies by 5° C. to 90° C. during the injecting, that is, the temperature varies over a range of 5° C. to 10° C., or 10° C. to 15° C., or 15° C. to 20° C., or 20° C. to 25° C., or 25° C. to 30° C., or 35° C. to 40° C., or 40° C. to 45° C., or 45° C. to 50° C., or 50° C. to 55° C., or 55° C. to 60° C., or 60° C. to 65° C., or 65° C. to 70° C., or 70° C. to 75° C., or 75° C. to 80° C., or 80° C. to 85° C., or 85° C. to 90° C. during the injecting; and/or further wherein the pressure varies by 0.1 MPa to 40 MPa during the injecting, that is, the pressure varies over a range of 0.1 MPa to 0.5 MPa, or 0.5 MPa to 1.0 MPa, or 1.0 MPa to 2.0 MPa, or 2.0 MPa to 5 MPa, or 5 MPa to 10 MPa, or 10 MPa to 15 MPa, or 15 MPa to 20 MPa, or 20 MPa to 25 MPa, or 25 MPa to 30 MPa, or 30 MPa to 35 MPa, or 35 MPa to 40 MPa during the injecting.

In one exemplary but nonlimiting embodiment, a stable treatment solution obtains a solution during an umbilical injection into a subsea reservoir, during which the temperature and pressure proximal to the umbilical is 20° C./0.1 MPa at the umbilical first end situated above the sea surface; is 5° C./25 MPa at a location on the umbilical 1000 to 1200 meters below the sea surface; and is 90° C./30 MPa at the umbilical second end, located in fluid contact with the subsea wellhead 1500 meters below the sea surface. During the foregoing exemplary injection, the stable treatment solution is subjected to a temperature variation of 85° C., and pressure variation of 29.9 MPa, while remaining a solution. Other exemplary conditions to which materials flowing within a subsea umbilical may be subjected will be readily envisioned by one of ordinary skill in the art of subsea hydrocarbon recovery, and it will be appreciated that the stable treatment solutions herein obtain a solution when subjected to any of these conditions, and do not undergo phase separation, freezing, or gelation.

Upon contacting a treatment composition with a crude oil located within a wellhead, the crude oil is transformed into a treated crude oil. The treated crude oil is suitably collected using conventional crude oil collection processes; and may be further purified or refined.

### Fourth Embodiments

In fourth embodiments herein, treated crude oils are disclosed. A treated crude oil is formed and collected using the methods of third embodiments. Accordingly, a treated crude oil comprises, consists essentially of, or consists of a crude oil and one or more sulfonate polymers of first embodiments, or a sulfonate mixture of second embodiments. Accordingly, a treated crude oil obtains a reduced amount of asphaltene fouling compared to a corresponding untreated crude oil. An untreated crude oil is a crude oil that does not contain or include any sulfonate polymers of first embodiments, or any sulfonate mixture of second embodiments—that is, an untreated crude oil excludes sulfonate polymers of first embodiments, and also excludes sulfonate mixtures of second embodiments.

Depending on context, a “corresponding untreated crude oil” means an untreated crude oil collected from the same reservoir as the treated crude oil; or the same crude oil, prior to adding one or more sulfonate polymers of first embodiments, or a sulfonate mixture of second embodiments.

Accordingly, in fourth embodiments herein, a treated crude oil comprises, consists essentially of, or consists of a crude oil combined with 0.1 ppm to 10,000 ppm by weight of one or more sulfonate polymers of first embodiments, or 0.1 ppm to 10,000 ppm by weight of one or more sulfonate mixtures of second embodiments. In some embodiments the treated crude oil comprises, consists essentially of, or consists of a crude oil combined with 0.1 ppm to 1000 ppm, or 10 ppm to 1000 ppm, or 50 ppm to 1000 ppm, or 100 ppm to 1000 ppm, or 200 ppm to 1000 ppm, or 300 ppm to 1000 ppm, or 400 ppm to 1000 ppm, or 500 ppm to 1000 ppm, or 600 ppm to 1000 ppm, or 700 ppm to 1000 ppm, or 800 ppm to 1000 ppm, or 900 ppm to 1000 ppm, or 0.1 ppm to 500 ppm, or 1 ppm to 500 ppm, or 10 ppm to 500 ppm, or 100 ppm to 500 ppm, or 200 ppm to 500 ppm, or 300 ppm to 500 ppm, or 400 ppm to 500 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 0.1 ppm to 100 ppm, or 1 ppm to 100 ppm, or 10 ppm to 100 ppm, or 100 ppm to 500 ppm, or 500 ppm to 700 ppm, or 700 ppm to 1000 ppm by weight of one or more sulfonate polymers of first embodiments, or sulfonate mixtures of second embodiments.

The treated crude oil of fourth embodiments obtains unexpectedly superior asphaltene antifouling properties, wherein “antifouling” refers to asphaltenes present in the crude oil, and the reduction or elimination of the association of the asphaltenes with a solid-liquid interface, that is, deposition of asphaltene solids onto the surface of tubes or pipes contacted by the crude oil having the asphaltene entrained therein. In embodiments, a crude oil includes as much as 1 wt % to 40 wt % asphaltene content, often between 5 wt % and 20 wt % asphaltene, wherein the asphaltene is dispersed, that is, entrained or included within the crude oil, and may be dissolved or partially dissolved therein; further wherein the asphaltene can become associated with solid-liquid interfaces encountered during extraction of the crude oil from the reservoir. Accordingly, asphaltene fouling of the interior surfaces of pipes, tubes, and other equipment contacted by the crude oil during the extraction thereof from a reservoir leads to extensive issues with flow control of the extraction process overall, and down time for cleaning of fouled surfaces. Fouling can become more extensive when the extraction is from a subsea reservoir, where changes in pressure applied to the crude oil as it is lifted from the subsea reservoir to a point above the surface of the sea exacerbate the instability of the asphaltene dispersed within the crude oil.

In embodiments, the treated crude oil of fourth embodiments obtains at least a 30% reduction in asphaltene fouling compared to an untreated crude oil obtained from the same reservoir, and in embodiments up to a 99% reduction in asphaltene fouling compared to an untreated crude oil obtained from the same reservoir, where the reduction is determined by mixing a crude oil with 1000 ppm by w/v of one or more sulfonate polymers of first embodiments, or a sulfonate mixture of second embodiments; heating the treated crude oil in a vessel; then measuring the weight of residual materials that remain on the bottom of the vessel after pouring the liquid contents from the vessel, washing the residual materials with hexane, washing the residual materials further with toluene, and drying the remaining residue, and comparing the amount of residue remaining after testing the treated crude oil to the amount remaining after carrying out the same test on an untreated sample of the crude oil obtained from the same reservoir.

Accordingly, the treated crude oil of fourth embodiments obtains a 30%-99% reduction in asphaltene fouling compared to the corresponding untreated crude oil, that is, an untreated crude oil obtained from the same reservoir. Stated differently, compared to the weight of asphaltene deposited on a surface by contacting the surface with an untreated crude oil, 30%-90% less asphaltene is deposited on the surface by a corresponding treated crude oil subjected to the same contacting conditions of temperature and pressure.

### EXPERIMENTAL SECTION

Asphaltene fouling test: asphaltene fouling was measured using a glass reactor vessel fitted with overhead stirrer, thermocouple, and heating mantle, and having a location for mounting a 6 cm×10 cm metal mesh insert on the vessel bottom. For each measurement, a fresh 6 cm×10 cm stainless steel mesh piece was cut and weighed; then fitted to the bottom of the clean reactor. Then 20 mL of a crude oil obtained from a well located beneath the Gulf of Mexico and determined to have 14 wt % asphaltene content (“GoM crude oil”) was added to the reactor, along with 1000 ppm by weight/volume of an asphaltene antifouling formulation to be tested, if any. Then the reactor was closed, and stirring at 436 rpm was started. Then the heating mantle was turned on and the contents of the reactor were allowed to warm to a set temperature of 161° C. while the stirring was continued. The contents of the vessel were maintained at the set temperature and a timer was started. When the timer reached 90 minutes, the heating mantle was shut off and the vessel immediately immersed in cool tap water. The vessel was held in the cool water until the contents reached a temperature of 64° C. or lower; then the vessel was slowly opened to release any pressure; and the metal mesh removed therefrom and dried in an oven set to 80° C. The mesh was then washed with cyclohexane, dried in an oven set to 80° C., and cooled; and finally the mesh was washed with toluene, dried in an oven set to 80° C., and cooled. The washed, dried mesh was weighed, and the weight of the tared mesh screen was subtracted from this to reveal the mass of materials associated with the mesh screen. The mass of the materials associated with the mesh screen indicates the relative amount of asphaltene fouling expected by a crude oil, or by a treated crude oil, during extraction thereof.

The asphaltene fouling test using untreated GoM crude oil showed that the 20 mL of GoM crude oil deposited 12 mg residue on the mesh screen. For comparison, dodecyl benzene sulfonic acid was also tested, wherein 1000 ppm DDBSA by weight was added to 20 mL of the GoM crude oil in the test, to result in about 10 mg residue deposited on the mesh screen, a 17% reduction compared to the untreated GoM crude oil. Finally, a poly(sodium methylene naphthalene sulfonate) (NaMNS) was tested, wherein 1000 ppm of the NaMNS was added to 20 mL of the GoM crude oil to result in about 5 mg residue deposited on the mesh screen, that is, a 57% reduction compared to the untreated GoM crude oil.

What is claimed is:

1. A treatment composition comprising 0.1 ppm to 10,000 ppm by weight of one or more sulfonate polymers in a solvent, wherein the one or more sulfonate polymers are selected from poly(methylene naphthalene sulfonate) homopolymers and copolymers, branched or crosslinked polymers having pendant benzenesulfonate moieties, and any combination thereof; and the solvent is a compound or a mixture of compounds that is liquid within at least a portion of the range between 0° C. and 100° C. at 1 atmosphere pressure, and includes one or more compounds having a flashpoint of 100° C. or less.

2. The treatment composition of claim 1, wherein the solvent is insoluble in water.

3. The treatment composition of claim 1 wherein the solvent is selected from toluene, xylene, heavy aromatic naphtha, diesel fuels, kerosenes, heavy aromatic distillates, gasolines, or any mixture thereof.

4. The treatment composition of claim 1, further comprising one or more sulfonate salts having the formula (R—SO³⁻)ₙXⁿ⁺, wherein n is an integer between 1 and 4, R is a hydrocarbyl moiety having between 10 and 40 carbons and optionally including one or more hydroxyl moieties, and
where n=1, X is Na, Ka, Li, K, NH₄, NH₃—CH₂—CH₂—OH, or NH₂(CH₂—CH₂—OH)₂;
where n=2, X is Mg, Zn, Zr, Ba, or Ca;
where n=3, X is Al, Mn, or Fe; and
where n=4, X is Ti or Zr,
further wherein the treatment composition comprises a total of 0.1 ppm to 10,000 ppm by weight of the combination of the one or more sulfonate polymers and the one or more sulfonate salts.

5. The treatment composition of claim 4 wherein the weight ratio of the one or more sulfonate salts to the one or more sulfonate polymers is between 100:1 and 1:100.

6. The treatment composition of claim 1 wherein the sulfonate polymer comprises one or more repeating units having formula (a):

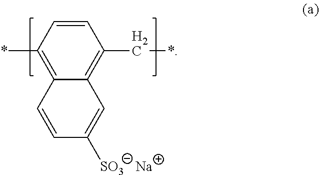

7. The treatment composition of claim 6 wherein the sulfonate polymer is a homopolymer.

8. The treatment composition of claim 6 wherein the sulfonate polymer is a copolymer further comprising one or more repeating units derived from the condensation of formaldehyde with phenol, resorcinol, or a combination thereof.

9. The treatment composition of claim 1 disposed within a subsea umbilical, wherein the subsea umbilical is in fluid contact with a subsea reservoir, optionally wherein the subsea umbilical is one part of a subsea tree.

10. The treatment composition of claim 9 wherein the fluid contact with the subsea reservoir comprises fluid contact within a wellhead of the subsea reservoir or proximal to a wellhead of the subsea reservoir.

11. The treatment composition of claim 1 wherein the treatment composition is a treatment solution.

12. The treatment composition of claim 1, wherein the treatment composition further comprises a total of 0.1 ppm to 10,000 ppm of one or more adjuvants selected from: one or more corrosion inhibitors, one or more antipolymerants, one or more paraffin inhibitors, one or more corrosion inhibitors, one or more antiscale agents, one or more defoaming agents, one or more emulsifiers, one or more demulsifiers, and one or more biocides.

13. A treated crude oil comprising
a crude oil; and either:
(a) 0.1 ppm to 10,000 ppm by weight of one or more sulfonate polymers selected from poly(methylene naphthalene sulfonate) homopolymers and copolymers, branched or crosslinked polymers having pendant benzenesulfonate moieties, and any combination thereof; or
(b) 0.1 ppm to 10,000 ppm by weight of a mixture of one or more sulfonate polymers with one or more sulfonate salts,
wherein the one or more sulfonate polymers are selected from poly(methylene naphthalene sulfonate) homopolymers and copolymers, branched or crosslinked polymers having pendant benzenesulfonate moieties, and any combination thereof; and
wherein the one or more sulfonate salts have the formula (R—SO³⁻)ₙXⁿ⁺, wherein n is an integer between 1 and 4, R is a hydrocarbyl moiety having between 10 and 30 carbons and optionally including one or more hydroxyl moieties, and
where n=1, X is Na, Ka, Li, K, NH₄, NH₃—CH₂—CH₂—OH, or NH₂(CH₂—CH₂—OH)₂;
where n=2, X is Mg, Zn, Zr, Ba, or Ca;
where n=3, X is Al, Mn, or Fe; and
where n=4, X is Ti or Zr.

14. The treated crude oil of claim 13 wherein the one or more sulfonate polymers of (a) and/or (b) comprises a poly(sodium methylene naphthalene sulfonate) homopolymer.

15. The treated crude oil of claim 13 wherein n=1 and X is Na or NH₄.

16. The treated crude oil of claim 13 wherein the mixture (b) comprises a weight proportion of the one or more sulfonate polymers to the one or more sulfonate salts of 100:1 to 1:100.

17. A method of recovering a hydrocarbon from a reservoir, the method comprising
(a) combining a solvent with 0.1 ppm to 10,000 ppm by weight of one or more sulfonate polymers to form a treatment composition;
(b) contacting the treatment composition with a crude oil disposed within the reservoir to form a treated crude oil; and
(c) collecting the treated crude oil from the reservoir,
wherein the one or more sulfonate polymers are selected from poly(methylene naphthalene sulfonate) homopolymers and copolymers, branched or crosslinked polymers having pendant benzenesulfonate moieties, and any combination thereof.

18. The method of claim 17 wherein the reservoir is a subsea reservoir, and the contacting comprises applying the treatment composition to a subsea umbilical, and flowing the treatment composition through the subsea umbilical and into the subsea reservoir.

19. The method of claim 18 wherein a temperature proximal to the treatment composition during the flowing is between 0° C. and 90° C., and/or wherein a temperature proximal to the treatment composition varies by 5° C. to 90° C. during the flowing.

20. The method of claim 18 wherein a pressure proximal to the treatment composition during the flowing is between 0.1 MPa and 40 MPa and/or wherein a pressure proximal to the treatment composition varies by 0.1 MPa to 40 MPa during the flowing.
